(19) United States
(12) Patent Application Publication
(10) Pub. No.: US 2018/0047118 A1
(43) Pub. Date: Feb. 15, 2018

(54) FOOD TRUCK VENDING

(71) Applicant: Jeremy Deutsch, New York, NY (US)

(72) Inventor: Jeremy Deutsch, New York, NY (US)

(21) Appl. No.: 15/676,010

(22) Filed: Aug. 14, 2017

Related U.S. Application Data
(60) Provisional application No. 62/374,356, filed on Aug. 12, 2016.

(51) Int. Cl. G06Q 50/12; G06Q 30/06; G06Q 20/32

(52) U.S. Cl. CPC G06Q 50/12; G06Q 20/322; G06Q 30/0633

(57) ABSTRACT

Efficient distribution of goods and services, and, more particularly, a method and system for vending goods to remote users from a temporary location, is disclosed. A user may place an order with a vendor via a mobile application.

### FIELD OF THE INVENTION

The present invention relates to efficient distribution of goods and services, and, more particularly, a method and system for vending goods to remote users from a temporary location.

### BACKGROUND

In the known art, various types of take-out food access are known. For example, it may be typical that one dials the number for a pizza parlor, places an order over the phone, and goes to pick-up and pay for the pizza. Moreover, it is known that, in large urban areas, so called “food trucks” are common for vending of foodstuffs, in which food is cooked, and customers wait in a line at a window of the food truck to order and pay for the food made in the truck.

However, in the particular embodiment of a food truck, inconvenience is heightened because one must wait in the line, place an order, and wait for the order to be cooked/made prior to paying for and departing with the food. Because food trucks are often in urban areas where persons are particularly busy, such as because of type of employment-type, this waiting time period can prove exceedingly inconvenient and unproductive.

Therefore, the need exists for a take-out method for food from a temporary vending location that is more expedient and efficient than in the known art.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

FIG. 1 illustrates an aspect of an exemplary embodiment of the present invention.

FIG. 2 illustrates an aspect of an exemplary embodiment of the present invention.

FIG. 3 is an overview diagram of the present invention.

FIG. 4 is a workflow process of the present invention.

### DETAILED DESCRIPTION

While the concepts of the present disclosure are susceptible to various modifications and alternative forms, specific embodiments thereof are shown by way of example in the drawings and are described in detail below. It should be understood that there is no intent to limit the concepts of the present disclosure to the particular forms disclosed. On the contrary, the intent is to cover all modifications, equivalents, and alternatives consistent with the present disclosure and the appended claims.

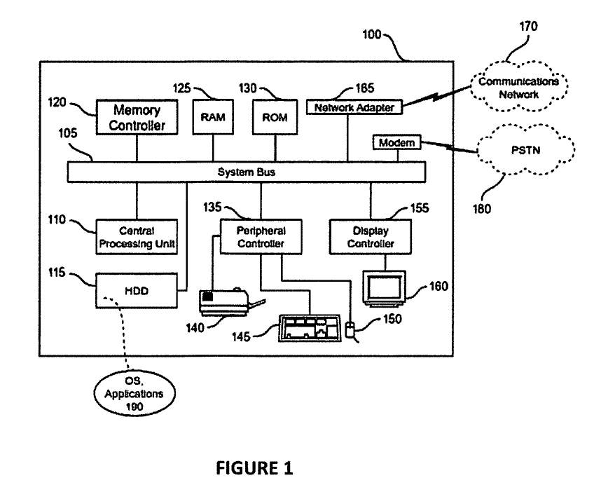

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

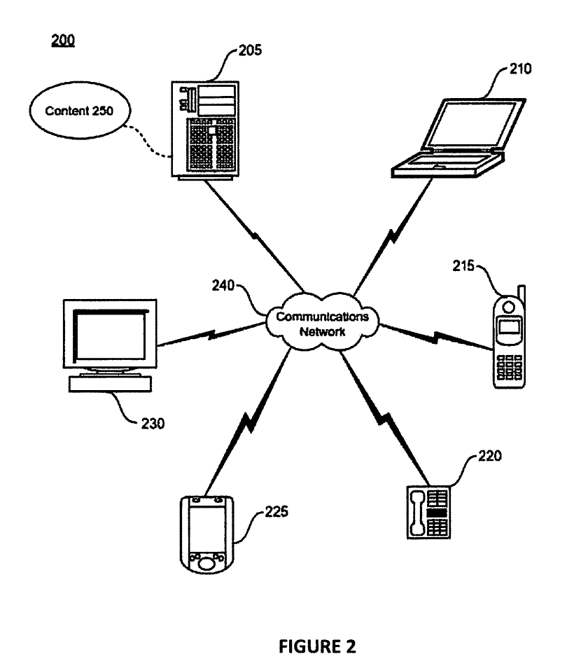

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

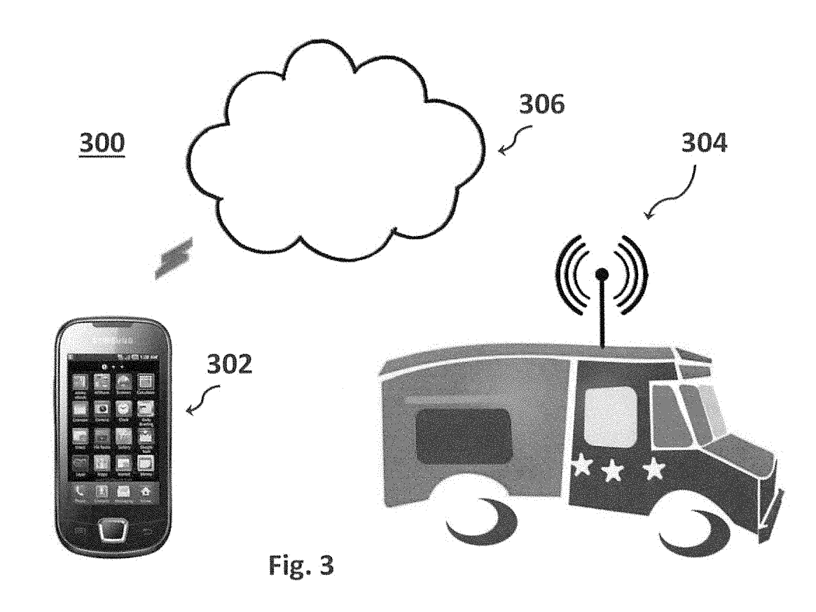

FIG. 3 shows an overall high level diagram 300 of at least one embodiment of the invention. A user, via at least one mobile device 302, may access information related to one or more available vendors (as described below) via a network 306. The network 306 may comprise the Internet, a LAN, or the like. The network may further include a server and/or a database (not shown) used to track, in real-time or near real-time, one or more available vending locations 304. The vending locations may be temporary or permanent and may comprise vendors selling perishable and non-perishable items, such as food, drink, flowers, jewelry, or the like.

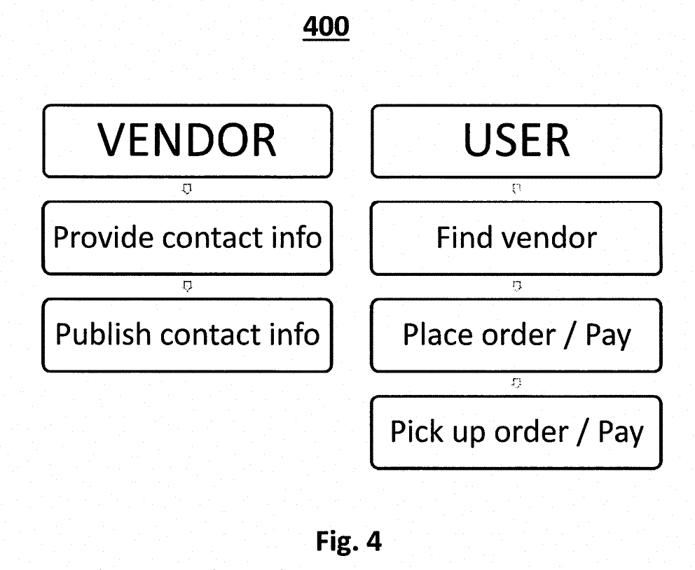

The disclosed exemplary embodiments are illustrated in the flow diagram 400 of FIG. 4. In the illustration, either a vending truck may have a phone number, such as in relation to a mobile phone, associated with the particular truck, or a phone number may be associated with a series of trucks, to enable provision of a service, such as a vending truck order service. The number, of course, may be published via any means known in the art, such as online, by paper, or by word of mouth.

In the illustration, a customer dials either a direct number of a food truck, a series of food trucks, or an associated vending service, and places and order, such as from a menu published on, for example, an ordering app or on the Internet. That is, included in the reference to phone calls made herein, orders may be placed through one or more apps/applications, such as dedicated mobile phone apps.

Following the step of placement of the order, a user may optionally pay for the order. Such payments may be received, for example, over the phone, or via the app referenced, such as using a credit card, Paypal®, Google Wallet®, or any similar known payment methodology. Alternatively, those skilled in the art will appreciate that payment may not be made until the customer arrives at the vending truck to pick-up the food, although the likelihood that the food will be made but the customer will never come and pick the food up, and hence no payment for the food will ever be made, is obviously heightened if the food is paid for only upon arrival at the food truck.

It may additionally be that a user may place an order, such as via telephone or the aforementioned app, for particular food stuffs, and the user may be matched with a vending truck that is closest to the user geographically, to a vending truck from which the user most frequently orders food stuffs (such as via tracking of prior orders, geographic position of the user's phone, or the like), to the highest rated vending truck offering similar food stuffs in the geographic area of the user, or the like. That is, there may be no singular truck to fulfill orders for particular food stuffs, but rather the food truck network may allow for distribution of orders of particular food stuffs among multiple trucks.

The user may receive an indication of the time period in which the food will be ready when the order is placed, or may later receive such an indication, such as over the app, via text message, via return phone call, or the like, wherein it is indicated to the user that the food has been prepared. Once the food has been prepared, the user may proceed to the vending truck and pick-up the order, such as via dedicated window for pre-orders, and accordingly the user may not have to wait in line to pick-up the order nor must the user wait while the food is made.

In additional and alternative embodiments, such as wherein an ordering service is used as discussed above, a delivery service may also be provided. That is, a delivery service may pick-up ordered foods stuffs from vending trucks, such as upon indication that food is ready at a particular food truck after ordering from that food truck through an app, and a delivery person may take the food stuffs and deliver to the ordering customer. Needless to say, such a delivery service may use distributed delivery, such that deliveries may be efficiently targeted in certain locations, or in a certain order, based on the concentration of orders for particular food stuffs, orders from particular vending trucks, or the like. A significant factor in such distribution of delivery, as well as in distribution of order placement, may be geographic proximity between an ordering customer and a vending truck offering particular food stuffs, although other known factors may, of course, be considered.

1. A method for ordering an item from a vendor, the method comprising, with at least one mobile computing device:
locating at least one vendor;
receiving a request from the at least one mobile computing device; and
fulfilling the request by the at least one vendor.

2. The method of claim 1, wherein the at least one vendor is a food truck.

3. The method of claim 1, wherein the at least one vendor is located at a temporary location.

4. The method of claim 1, further comprising:
tracking a geographical location of the at least one vendor.

5. The method of claim 1, wherein the request includes at least one order to be placed with the at least one vendor.

6. The method of claim 5, wherein the request further includes payment information.

7. The method of claim 5, wherein the request further includes location information.
